(19) United States
(12) Patent Application Publication
(10) Pub. No.: US 2015/0067235 A1
(43) Pub. Date: Mar. 5, 2015

(54) MEMORY SYSTEM AND DATA WRITING METHOD

(71) Applicant: Kabushiki Kaisha Toshiba, Minato-ku (JP)

(72) Inventor: Nobuyuki MYOUGA, Iruma-shi (JP)

(73) Assignee: Kabushiki Kaisha Toshiba, Minato-ku (JP)

(21) Appl. No.: 14/091,647

(22) Filed: Nov. 27, 2013

Related U.S. Application Data
(60) Provisional application No. 61/870,475, filed on Aug. 27, 2013.

(51) Int. Cl. G06F 3/06

(52) U.S. Cl. CPC G06F 3/0659; G06F 3/0679; G06F 3/061
USPC 711/103

(57) ABSTRACT

According to one embodiment, a memory system including plural processing units, each of which is provided for each transmission path, and a data distribution unit, is provided. The data distribution unit distributes a data frame to a write control unit that has execution management information including identification information equal to identification information in the received data frame, in the case where the same address is set to the input/output units in the plural processing units. The data distribution unit transfers the data frame to the write control unit in the processing unit including the input/output unit from which the data frame is received, in the case where a different address is set to the input/output unit in each of the processing units.

### CROSS-REFERENCE TO RELATED APPLICATIONS

This application is based upon and claims the benefit of priority from U.S. Provisional Application No. 61/870,475, filed on Aug. 27, 2013; the entire contents of which are incorporated herein by reference.

### FIELD

Embodiments described herein relate generally to a memory system and a data writing method.

### BACKGROUND

In order to receive and transmit data between a storage device and a host computer, the storage device includes an input/output unit that transmits and receives a command or data with the host computer, and a write/read control unit that reads or writes data based upon the command. The reading or writing of the data to the storage device is generally performed based on a protocol called SAS (Serial Attached SCSI (Small Computer System Interface)).

The SAS can be used for the case where plural input/output units are provided as an interface with the host computer. For example, each of the plural input/output units can be used as a narrow port having different SAS address, or the plural input/output units can be used as a wide port having the same SAS address.

Which one of the narrow port and the wide port is used by a user cannot preliminarily be found. Therefore, the storage device is configured to be used as both the narrow port and the wide port. Firmware can rewrite whether the storage device is used as the narrow port configuration or as the wide port configuration.

Under the SAS protocol, there is a difference in the process of receiving a write command from the host computer between the case of the narrow port configuration and the case of the wide port configuration. Therefore, the storage device is conventionally provided with a complicated circuit structure in order to be used as both configurations.

### BRIEF DESCRIPTION OF THE DRAWINGS

FIG. 1 is a sequence diagram illustrating one example of a write command protocol of a SAS;

FIG. 2 is a view illustrating one example of a frame format of the SAS;

FIG. 3 is a view schematically illustrating a configuration of the storage device according to the first embodiment;

FIG. 4 is a view illustrating one example of a configuration of an execution management table;

FIG. 5 is a view schematically illustrating a configuration of a data distribution unit;

FIG. 6 is a view schematically illustrating the configuration of the storage device that is used as a narrow port configuration;

FIG. 7 is a flowchart illustrating one example of a procedure of an execution process of a write command in the narrow port configuration according to the first embodiment;

FIG. 8 is a flowchart illustrating one example of a procedure of an execution process of the write command in the wide port configuration according to the first embodiment;

FIG. 9 is a view illustrating one example of a data distribution process using TPTT as identification information; and

FIG. 10 is a view illustrating one example of a data distribution process by the data distribution unit according to a second embodiment.

### DETAILED DESCRIPTION

In general, according to one embodiment, a memory system that is connected to a host computer with plural transmission paths, and writes data in a non-volatile memory by a write command from the host computer is provided. The memory system includes plural processing units provided for each of the transmission paths, and a data distribution unit. Each processing unit includes an input/output unit that transmits and receives data with the host computer, and a write control unit that has execution management information for queuing write commands, the execution management information including identification information indicating a process involved with the write command, and that controls a writing of data to the non-volatile memory based upon the execution management information. The data distribution unit distributes the data frame received from any one of the input/output units to any one of the writing control units based upon the identification information in the data frame. The data distribution unit distributes the data frame to the write control unit that has the execution management information including identification information equal to the identification information in the received data frame, in the case of a first configuration in which the same address is set to the input/output units in the plural processing units. The data distribution unit does not distribute the data frame, but transfers the data frame to the write control unit in the processing unit including the input/output unit from which data frame is received, in the case of a second configuration in which a different address is set to the input/output unit in each of the processing units.

Exemplary embodiments of the memory system and the data writing method will be explained below in detail with reference to the accompanying drawings. The present invention is not limited to the following embodiments. After an outline of a SAS interface protocol is described, the embodiments will be described.

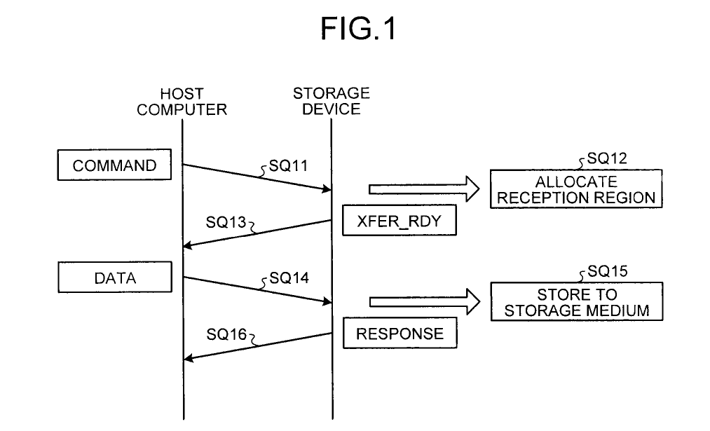

FIG. 1 is a sequence diagram illustrating one example of a write command protocol of a SAS. In the write command of the SAS, COMMAND frame that is transmitted from a host computer and includes a data writing instruction is issued to a storage device (SQ11). The storage device receiving this COMMAND frame performs a process of securing a receiving region with a size of the data designated by the COMMAND frame (SQ12). When finishing the preparation for receiving the data, the storage device notifies the host computer of this situation by transfer ready (hereinafter referred to as XFER_RDY) frame (SQ13). Then, the host computer transmits the data to the storage device with DATA frame (SQ14), and the storage device writes the received data onto a storage medium (SQ15). After writing the data, the storage device reports to the host computer as to whether the data writing is normally completed or not by RESPONSE frame (SQ16). This is the outline of the process of the write command in the protocol of the SAS interface.

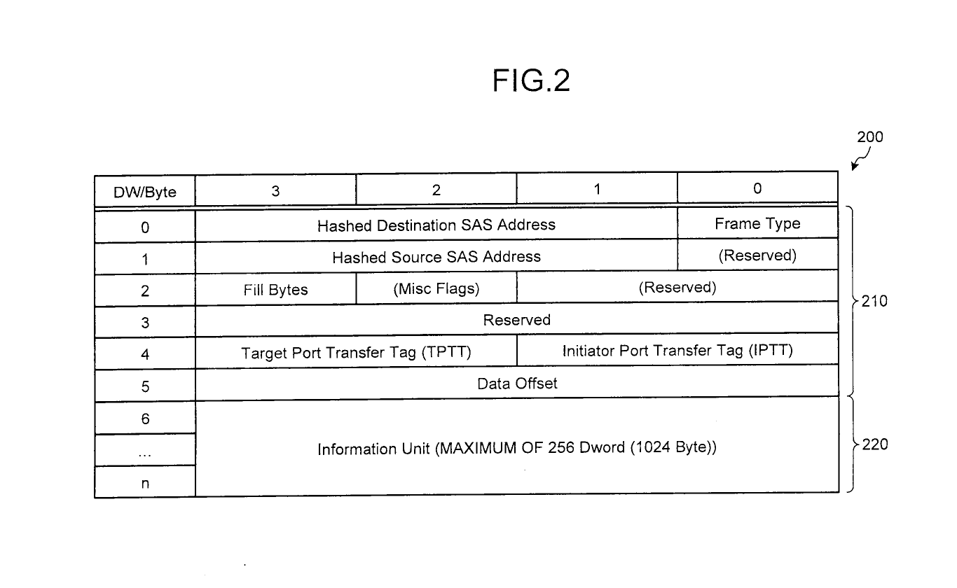

FIG. 2 is a view illustrating one example of a frame format of the SAS. A frame format 200 of the SAS includes a header 210 and a data portion 220. The header 210 includes a frame type, a destination SAS address, a source SAS address, an Initiator Port Transfer Tag (hereinafter referred to as IPTT), and a Target Port Transfer Tag (hereinafter referred to as TPTT).

The frame type indicates a type of a frame, specifically, indicates the COMMAND frame, XFER_RDY frame, DATA frame, or RESPONSE frame in FIG. 1. The SAS address is an address assigned to the interface units for the host computer and the storage device. The destination SAS address indicates a transmission destination of the frame, and the source SAS address indicates a transmission source of the frame.

The IPTT is a tag applied from the COMMAND frame upon an issuance of the command, and it is identification information for identifying that the frame is a process frame involved with the COMMAND frame issued from the host computer. Specifically, when the COMMAND frame is issued as illustrated in FIG. 1, the XFER_RDY frame, the DATA frame, and the RESPONSE frame are sent and received between the host computer and the storage device, and the IPTT is the identification information applied to a series of frames sent and received. Even when plural COMMAND frames are issued, it can be identified with which COMMAND frame the XFER_RDY frame, the DATA frame, or the RESPONSE frame is involved by the IPTT.

The TPTT is a tag applied when the storage device transmits the XFER_RDY frame independently of the IPTT. The TPTT is information for identifying the DATA frame corresponding to the XFER_RDY frame that is a response frame to the COMMAND frame. When the region with the data size required by the COMMAND frame cannot be allocated at a time in SQ12 in FIG. 1, the storage device transmits plural XFER_RDY frames every time plural regions with the size less than the required data size are allocated. The TPTT is the information for identifying to which one of the XFER_RDY frames the DATA frame corresponds.

The data portion 220 stores different contents for each frame type. In the case of the DATA frame, the data to be written on the storage device is stored.

### First Embodiment

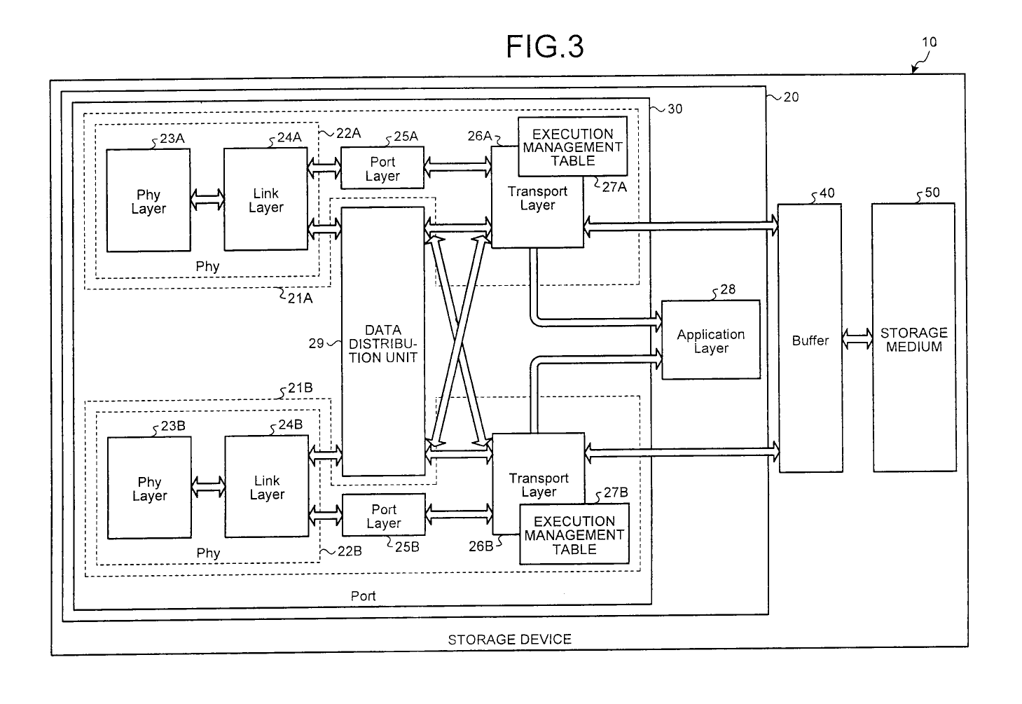

FIG. 3 is a view schematically illustrating a configuration of the storage device according to the first embodiment. A storage device 10 includes a SAS module 20, a buffer 40, and a storage medium 50.

The SAS module 20 is an interface for connecting the storage device 10 to the host computer, serving as an Initiator, in a SAS system. In this embodiment, the SAS module 20 includes two interface units 21A and 21B, an Application Layer 28, and a data distribution unit 29.

The interface units 21A and 21B respectively include Phys 22A and 22B, Port Layers 25A and 25B, Transport Layers 26A and 26B, and execution control tables 27A and 27B. The present embodiment illustrates the SAS module including two interface units 21A and 21B. However, the SAS module may include three or more interface units.

The Phys 22A and 22B correspond to an input/output unit to the host computer, and include Phy Layers 23A and 23B, and Link Layers 24A and 24B respectively. The Phy Layers 23A and 23B convert an electric signal inputted from the host computer into a frame or a signal with a primitive unit for controlling communication, and input the converted frame or signal into the Link Layers 24A and 24B. The Phy Layers 23A and 23B convert the frame or the primitive signal inputted from the Link Layers 24A and 24B into an electric signal, and output the converted signal to the host computer.

The Link Layers 24A and 24B extract the frame inputted from the Phy Layers 23A and 23B or extract the frame from the signal that is inputted from the Phy Layers 23A and 23B and that includes both the frame and the primitive signal, and output the extracted frame to the Transport Layers 26A and 26B, as well as output a connection control signal, which controls the reading of the frame, to the Port Layers 25A and 25B. When receiving the connection control signal from the Port Layers 25A and 25B, the Link Layers 24A and 24B read the signal at the unit of frame from the Transport Layers 26A and 26B, add the primitive signal to the frame, and output the resultant to the Phy Layers 23A and 23B.

The Port Layers 25A and 25B perform connection control for transmitting and receiving the frame in cooperation with the Link Layers 24A and 24B and the Transport Layers 26A and 26B. Specifically, the Port Layers 25A and 25B transfer the connection control signal inputted from the Link Layers 24A and 24B to the Transport Layers 26A and 263. The Port Layers 25A and 25B also transfer the connection control signal inputted from the Transport Layers 26A and 26B to the Link Layers 24A and 24B.

The Transport Layers 26A and 26B discriminate the type of the frame inputted from the Link Layers 24A and 24B, decide the destination where the frame is to be stored according to the type, and store the frame into the decided destination, according to the connection control signal. For example, the Transport Layers 26A and 26B store the COMMAND frame into a command table, not illustrated, in the Application Layer 28, and store the DATA frame into the buffer 40.

The Transport Layers 26A and 26B also generate a frame to be transmitted by a protocol of the running command, and output the generated frame to the Link Layers 24A and 24B. For example, during the execution of the write command, after receiving the COMMAND frame, the Transport Layers 26A and 26B generate the XFER_RDY frame, and output the generated frame to the Link Layers 24A and 24B. After the reception of the DATA frame, the Transport Layers 26A and 26B generate the RESPONSE frame, and output the generated frame to the Link Layers 24A and 24B. During the execution of the read command, the Transport Layers 26A and 26B output the frame to be transmitted to the Link Layers 24A and 24B, and output the connection control signal for controlling the reading of this frame to the Port Layers 25A and 25B.

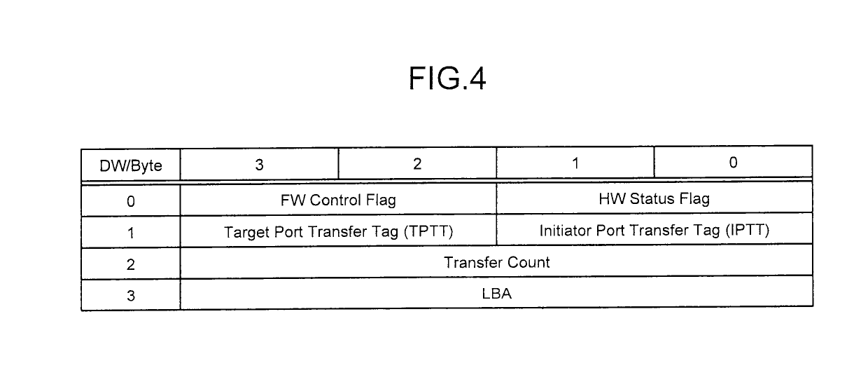

The execution management tables 27A and 27B store execution management information needed to queue the command from the host computer, and each of them is provided for each of the Transport Layers 26A and 26B. FIG. 4 is a view illustrating one example of a configuration of the execution management table. The execution management tables 27A and 27B manage information, such as TPTT, LBA (Logical Block Address), or a transfer number, for each IPTT. The LBA indicates a logical address on the storage medium 50 to which the writing is instructed by the write command. The transfer number is information indicating how much bytes of the data, which is instructed to be transferred by the COMMAND frame, can be received based upon an empty condition of the buffer 40. The execution management table in FIG. 4 includes FW Control Flag and HW Status Flag. The FW Control Flag is to instruct Hardware (HW) to execute various operation modes by FW, while the HW Status Flag indicates a status of the HW.

The number of the mounted execution management tables 27A and 27B are equal to the number of the commands that are to be simultaneously executed. For example, when two write commands are simultaneously executed in each of the Transport Layers 26A and 26B, two execution management tables 27A are provided to the Transport Layers 26A, and two execution management tables 27B are provided to the Transport Layers 26B.

The port Layers 25A and 25B, the Transport Layers 26A and 26B, and the execution management tables 27A and 27B correspond to a read/write processing unit. The read/write processing unit writes or reads data based upon the command inputted from the Phys 22A and 22B.

The Application Layer 28 has a register and a command table, which are involved with the setting of the whole storage device 10. The command table stores the command received from the host computer, and the command is read by Firmware (FW).

The portion composed of the Phy Layers 23A and 23B, the Link Layers 24A and 24B, the Port Layers 25A and 25B, the Transport Layers 26A and 26B, and the execution management tables 27A and 27B are particularly referred to as a Port 30. The configuration of the Port 30 is different between a narrow port configuration and a wide port configuration described later.

The Phy Layers 23A and 23B, the Link Layers 24A and 24B, the Port Layers 25A and 25B, the Transport Layers 26A and 26B, and the Application Layer 28 may be realized by using a dedicated chip according to each layer, or may be realized by using a chip having functions of several layers or all layers.

The data distribution unit 29 is provided between the Link Layers 24A and 24B and the Transport Layers 26A and 26B to connect two interface units 21A and 21B. When the two Phys 22A and 22B are used as the wide port configuration, the data distribution unit 29 distributes the data inputted from the Phys 22A and 22B to either one of two Transport Layers 26A and 26B. The detail of the data distribution unit 29 will be described later.

The buffer 40 is located between the Transport Layers 26A and 26B and the storage medium 50, and has a function of absorbing a difference between a communication speed with the host computer and a reading/writing speed of the storage medium 50.

The storage medium 50 stores the data received from the host computer in a non-volatile manner. Flash memory such as NAND flash memory or a magnetic disk (hard disk) can be used as the storage medium 50.

The narrow port and the wide port will be described. The SAS has the configuration called narrow port and the configuration called wide port according to the relationship of the Phys 22A and 22B located in the Port 30.

In the narrow port configuration, one Phy is included in one Port 30. Plural narrow ports can be mounted to one storage device 10. The configuration in which two narrow ports are provided in one storage device 10 is called dual port configuration. In the dual port configuration, each Port 30 (Phy) is regarded as independent, and a different SAS address is added to each Port 30. Therefore, the command received by each Port 30 has to be executed by the Port 30 that receives the command. The COMMAND frames having the same IPTT may simultaneously be transmitted to each of two Ports 30 (Phys). Specifically, in the dual port configuration, the host computer can treat each Port 30 as the independent interface of the storage device 10.

On the other hand, in the wide port configuration, plural Phys 22A and 22B are included in one Port 30 as illustrated in FIG. 3. In the wide port configuration, each of the Phys 22A and 22B are not regarded as independent, but has the same SAS address added thereto. Therefore, the command received by each of the Phys 22A and 22B does not have to be executed by the Phys 22A and 22B receiving the command. For example, in the write command, the DATA frame may be transmitted from any one of the Phys 22A and 22B that are located in the same Port 30, not limited to be transmitted from the Phys 22A and 22B that transmit the COMMAND frame and the Phys 22A and 22B that receive the XFER_RDY. In the wide port configuration, the simultaneous transmission of the COMMAND frames having the same IPTT to each of the Phys 22A and 22B in the same Port 30 is inhibited (if the COMMAND frames having the same IPTT are transmitted to each of the Phys 22A and 22B, the storage device 10 does not execute the commands as “Tag overlap”).

As described above, in the dual port configuration, each Port 30 (Phys 22A and 22B) is independent, and the DATA frame is always received from the Phy 22A or 22B that transmits the XFER_RDY frame. Therefore, the Transport Layers 26A and 26B and the execution management tables 27A and 27B are only provided for each Port 30 (each of the Phys 22A and 22B). On the other hand, in the wide port configuration, the DATA frame is not always received from the Phys 22A and 22B that transmit the XFER_RDY frame. Therefore, it has to be configured such that the DATA frame received by either one of the Phys 22A and 22B can be retrieved by the execution management tables 27A and 27B.

Whether the storage device 10 is used as the dual port (narrow port) configuration or as the wide port configuration can optionally be selected by the rewriting by the firmware. In order to allow the storage device 10 to be used as both the dual port (narrow port) configuration and the wide port configuration, the storage device 10 has basically the narrow port configuration, and includes the data distribution unit 29 provided between the Phys and the Transport Layers 26A and 26B to be connected to two Phys 22A and 22B.

The data distribution unit 29 recognizes the current port configuration of the storage device 10, and executes the data distribution process based upon the result. When the storage device 10 is used as the dual port configuration (as the narrow port configuration), the data distribution unit 29 does not operate, so that the storage device 10 functions as the narrow port. Specifically, the DATA frame received from the Link Layer 24A is transmitted to the Transport Layer 26A, and the DATA frame received from the Link Layer 24B is transmitted to the Transport Layer 26B.

When the storage device 10 is used as the wide port configuration, the data distribution unit 29 executes the distribution of the DATA frame in order that the DATA frame received by the Link Layer 24A can be transmitted to the Transport Layer 26B or the DATA frame received by the Link Layer 24B can be transmitted to the Transport Layer 26A. Identification information of the received DATA frame and identification information in the execution management tables 27A and 27B are compared, and the DATA frame is distributed to the Transport Layer 26A or 26B corresponding to the execution management table 27A or 27B having the identification information equal to the identification information of the DATA frame.

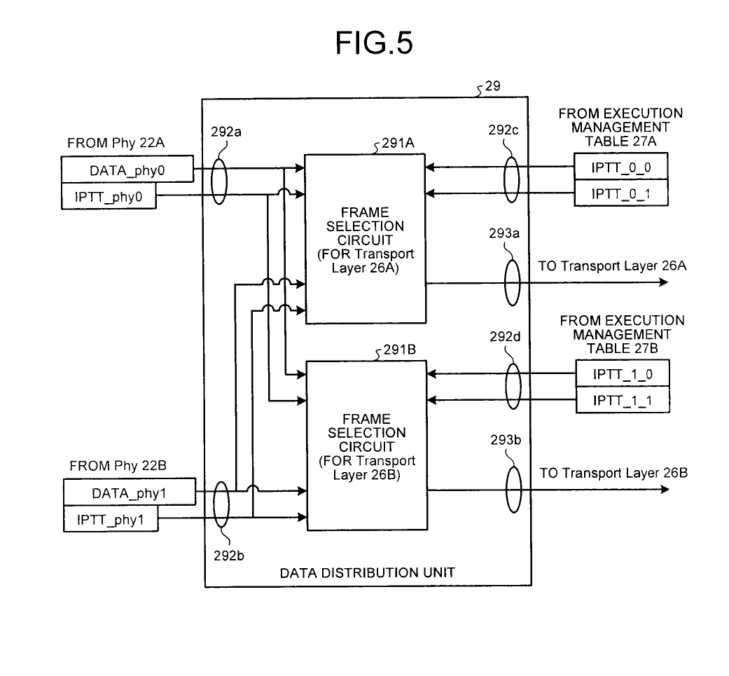

FIG. 5 is a view schematically illustrating the configuration of the data distribution unit. The data distribution unit 29 includes two frame selection circuits 291A and 291B, and also includes an input path 292a connected to the Phy 22A, an input path 292b connected to the Phy 22B, an input path 292c connected to the execution management table 27A, an input path 292d connected to the execution management table 27B, an output path 293a connected to the Transport Layer 26A, and an output path 293b connected to the Transport Layer 26B.

The signal from the input path 292a is inputted to the frame selection circuit 291A for the Transport Layer 26A, and the frame selection circuit 291B for the Transport Layer 26B. The signal from the input path 292b is inputted to the frame selection circuit 291A for the Transport Layer 26A, and the frame selection circuit 291B for the Transport Layer 26B. The signal from the input path 292c is inputted to the frame selection circuit 291A for the Transport Layer 26A. The signal from the input path 292d is inputted to the frame selection circuit 291B for the Transport Layer 26B. The signal selected by the frame selection circuit 291A for the Transport Layer 26A is outputted to the Transport Layer 26A. The signal selected by the frame selection circuit 291B for the Transport Layer 26B is outputted to the Transport Layer 26B.

The frame selection circuit 291A in the data distribution unit 29 compares the identification information in the DATA frame and the identification information in the execution management table 27A, and when they are equal to each other, the frame selection circuit 291A outputs the DATA frame to the output path 293a. When they are not equal to each other, the frame selection circuit 291A does not output the DATA frame to the output path 293a. The frame selection circuit 291B compares the identification information in the DATA frame and the identification information in the execution management table 27B, and when they are equal to each other, the frame selection circuit 291B outputs the DATA frame to the output path 293b. When they are not equal to each other, the frame selection circuit 291B does not output the DATA frame to the output path 293b. In the first embodiment, the IPTT is used as the identification information.

The operation of the storage device 10 in the first embodiment will next be described. In this embodiment, the case where the storage device 10 receives the write command will be described.

### <Case Where Storage Device is Used as Narrow Port Configuration>

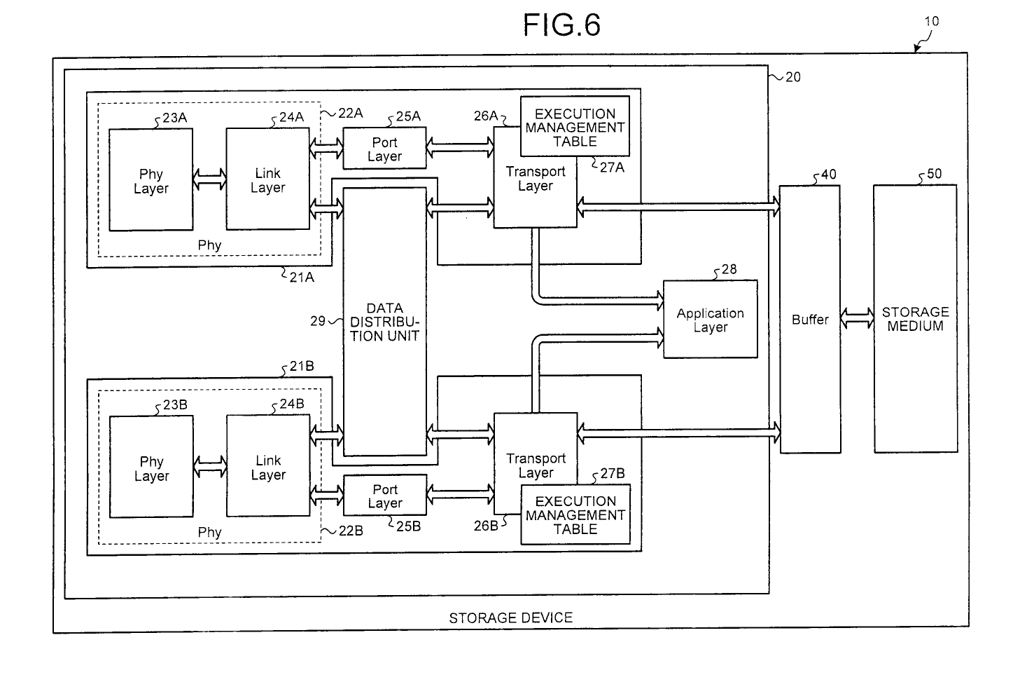

FIG. 6 is a view schematically illustrating the configuration of the storage device that is used as the narrow port configuration. As illustrated in this figure, each of the interface units 21A and 21B serves as one Port, when the storage device 10 is used as the narrow port configuration. Specifically, the Phy 22A, and the Port Layer 25A, the Transport Layer 26A, and the execution management table 27A that are connected to the Phy 22A form one Port, while the Phy 22B, and the Port Layer 25B, the Transport Layer 26B, and the execution management table 27B that are connected to the Phy 22B form one Port. A different SAS address is written on each Port by the firmware. Since each Port (Phy 22A and 22B) has the different SAS address allocated thereto, the storage device 10 recognizes that it is used as the narrow port (dual port) configuration. Therefore, the data distribution unit 29 does not execute the data distribution.

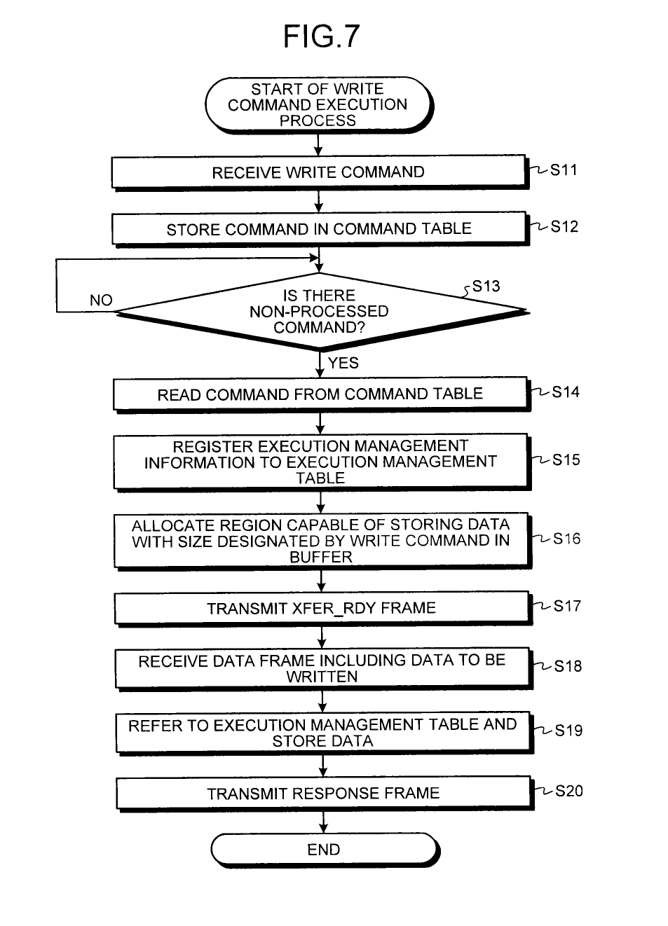

FIG. 7 is a flowchart illustrating one example of a procedure of an execution process of the write command in the narrow port configuration according to the first embodiment. When the storage device 10 receives the write command from the host computer (step S11), the command is stored in the command table, not illustrated, in the Application Layer 28 (step S12), and the number of the received commands is counted by a command counter, not illustrated, in the Application Layer 28.

The firmware monitors the command counter, and determines whether there is a command that is not processed (step S13). When there is no command that is not processed (No in step S13), the firmware is in stand-by state until the command that is not processed is generated. On the other hand, when there is the command that is not processed (Yes in step S13), the firmware reads the command from the command table (step S14), and registers the execution management information written on the command, such as the IPTT, LBA, or the transfer number, and the TPTT that is uniquely decided to the execution management table 27A (27B) (step S15). In this case, the identification information such as the IPTT or TPTT is registered in the execution management table in the interface unit including the Phy receiving the command. For example, the command received by the Phy 22A is registered in the execution management table 27A, and the command received by the Phy 22B is registered in the execution management table 27B. When there are plural commands that are not processed, each of these commands is registered to the execution management table 27A (27B). The number of the commands that can be simultaneously executed depends upon the number of the execution management tables 27A (27B) mounted on the storage device 10.

The Transport Layer 26A (26B) allocates the region that can store the data with the size designated by the write command in the buffer 40 (step S16). When the region with the designated size cannot be allocated, the setting of the execution management table for one write command is divided into plural settings.

After the firmware registers the execution management information to the execution management table 27A (27B), the XFER_RDY frame is transmitted to the host computer (step S17). Specifically, the Transport Layer 26A (26B) transmits the XFER_RDY frame to the Link Layer 24A (24B) based upon the information in the execution management table 27A (27B). The XFER_RDY frame includes the IPTT stored in the write command received in step S11. This frame also includes the TPTT. Thereafter, the Link Layer 24A (24B) adds the primitive to the received XFER_RDY frame, and transmits the resultant to the Phy Layer 23A (23B). The Phy Layer 23A (23B) converts the XFER_RDY frame into an electric signal, and transmits the converted signal to the host computer.

When receiving the XFER_RDY frame, the host computer transmits the DATA frame, which includes the data to be written instructed by the COMMAND frame, to the storage device 10.

Then, the storage device 10 receives the DATA frame (step S18). Specifically, after the Phy Layer 23A (23B) in the storage device 10 receives the DATA frame in the form of the electric signal, it converts the DATA frame into a signal in a frame/primitive unit. The Link Layer 24A (24B) extracts the DATA frame from the signal including both the frame and the primitive, and outputs the extracted frame to the Transport Layer 26A (26B), as well as outputs the connection control signal, which controls the reading of the DATA frame, to the Port Layer 25A (25B). The Port Layer 25A (25B) transfers the connection control signal to the Transport Layer 26A (26B). The data distribution unit 29 is present between the Link Layer 24A (24B) and the Transport Layer 26A (26B). However, in the narrow port configuration, it is set such that the data distribution unit 29 does not operate. Therefore, the DATA frame is only transferred to the Transport Layer 26A (26B) from the Link Layer 24A (24B) in the same interface unit 21A (21B).

When receiving the DATA frame, the Transport Layer 26A (26B) refers to the execution management table 27A (27B) in order to determine with which command the write data is involved by using the IPTT included in the DATA frame. After the write data is specified, the write data can be stored on the address indicated by the LBA in the storage medium 50 stored in the execution management table 27A (27B) via the buffer 40 in accordance with the connection control signal (step S19).

Then, the storage device 10 transmits to the host computer the RESPONSE frame indicating whether the write data is normally written or not (step S20). Specifically, after the writing of the write data is finished, the Transport Layer 26A (26B) generates the RESPONSE frame indicating whether the write data is normally written or not, and outputs the RESPONSE frame to the Link Layer 24A (24B). The RESPONSE frame is transmitted to the host computer via the Phy Layer 23A (23B). Thus, the write command execution process is ended.

The write command execution process described above is the same in the other port. As described above, the process same as the conventional process is executed in the narrow port configuration.

### <Case Where Storage Device is Used as Wide Port Configuration>

The configuration of the storage device used as the wide port configuration is as illustrated in FIG. 3. As illustrated in FIG. 3, when the storage device 10 is used as the wide port, two Phys 22A and 22B are included in one Port 30, and the same SAS address is allocated to both Phys 22A and 22B in one Port 30 by the firmware. Since same SAS address is allocated to both Phys 22A and 22B, the storage device 10 recognizes that it is used as the wide port configuration. Therefore, the data distribution unit 29 executes the data distribution.

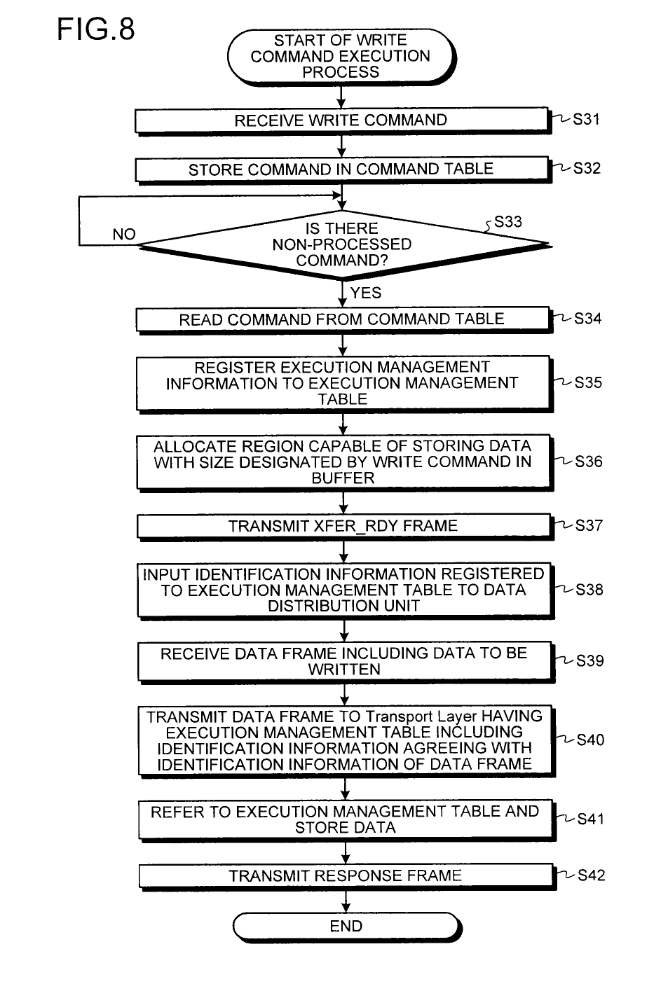

FIG. 8 is a flowchart illustrating one example of a procedure of an execution process of the write command in the wide port configuration according to the first embodiment. In the wide port configuration, after the write command is received, the execution management information is registered to the execution management table 27A (27B), the region for storing the data is allocated in the buffer 40, and the XFER_RDY frame is transmitted (steps S31 to S37), as in the processes of narrow port configuration in steps S11 to S17 in FIG. 7.

The method of registering the identification information such as the IPTT and TPTT to the execution management table in step S35 can be the same as the process in step S15 described in the narrow port configuration. In the dual port (narrow port) configuration, the execution management information has to be registered to the execution management table 27A or 27B mounted on the Transport Layer 26A or 26B connected to the Phys 22A or 22B receiving the COMMAND frame (because the XFER_RDY frame has to be transmitted from the Phy 22A or 22B receiving the COMMAND frame). However, the wide port configuration does not have such restriction. Accordingly, in the process of registering the execution management information to the execution management table in step S35, the execution management information may be registered to either one of the execution management tables 27A and 27B mounted on the Transport Layers 26A and 26B, so long as the execution management tables 27A and 27B are not used. For example, when the write command is received from the Phy 22A but there is no space in the execution management table 27A in the wide port configuration, the execution management information including the IPTT corresponding to the write command and the TPTT may be registered to the execution management table 27B, if the execution management table 27B has a free space; and vice versa.

Then, the IPTT of the command registered to the execution management table 27A or 27B is inputted to the data distribution unit 29 (step S38). This is because the IPTT is used for the distribution of the received data.

Thereafter, when receiving the XFER_RDY frame, the host computer transmits the DATA frame, which includes the data to be written instructed by the COMMAND frame, to the storage device 10. When the Phy Layer 23A or 23B in the storage device 10 receives the DATA frame in the form of the electric signal (step S39), it converts the DATA frame into a signal in a frame/primitive unit. The Link Layer 24A or 24B extracts the DATA frame from the signal including both the frame and the primitive, and output the extracted frame to the data distribution unit 29, as well as output the connection control signal, which controls the writing of the DATA frame, to the Port Layer 25A or 25B. The Port Layer 25A or 25B transfers the connection control signal to the Transport Layer 26A or 26B.

The data distribution unit 29 analyzes the IPTT of the DATA frame received from the host computer, and determines to which one of the execution management table 27A mounted on the Transport Layer 26A and the execution management table 27B mounted on the Transport Layer 26B the information involved with the DATA frame is registered. As a result of the determination, the data distribution unit 29 transmits the DATA frame to the Transport Layer 26A or 26B having the determined execution management table 27A or 27B (step S40).

The process of the data distribution unit 29 will be described in detail with reference to FIG. 5.

### (1) Distribution Process in Frame Selection Circuit 291A

The DATA frame from the input path 292a (hereinafter referred to as DATA_phy0) and the DATA frame from the input path 292b (hereinafter referred to as DATA_phy1) are inputted to the frame selection circuit 291A. In this embodiment, the IPTT of the DATA_phy0 is defined as “IPTT_phy0”, and the IPTT of the DATA_phy1 is defined as “IPTT_phy1”.

The IPTT of each execution management information stored in the execution management table 27A is also inputted to the frame selection circuit 291A. The execution management table 27A is supposed to store the execution management information whose IPTT is “IPTT_{—}0_{—}0” and “IPTT_{—}0_{—}1” in the present embodiment.

The frame selection circuit 291A compares the IPTT of the inputted DATA frame and the IPTT inputted from the execution management table 27A.

Specifically, the frame selection circuit 291A compares the IPTT_phy0 inputted from the input path 292a and the IPTT_{—}0_{—}0 and IPTT_{—}0_{—}1 inputted from the execution management table 27A, and compares the IPTT_phy1 inputted from the input path 292b and the IPTT_{—}0_{—}0 and IPTT_{—}0_{—}1 inputted from the execution management table 27A.

In the case of IPTT_phy0=IPTT_{—}0_{—}0 or IPTT_phy0=IPTT_{—}0_{—}1 as the result of the comparison, the frame selection circuit 291A outputs the DATA_phy0 from the input path 292a to the output path 293a (Transport Layer 26A). In the case of IPTT_phy1=IPTT_{—}0_{—}0 or IPTT_phy1=IPTT_{—}0_{—}1 as the result of the comparison, the frame selection circuit 291A outputs the DATA_phy1 from the input path 292b to the output path 293a (Transport Layer 26A). On the other hand, in other cases, the DATA frame is not transmitted to the output paths 293a (Transport Layer 26A) and 293b (Transport Layer 26B).

### (2) Distribution Process in Frame Selection Circuit 291B

The DATA_phy0, having the IPTT of the “IPTT_phy0”, from the input path 292a and the DATA_phy1, having the IPTT of the “IPTT_phy1”, from the input path 292b are inputted to the frame selection circuit 291B.

The IPTT of each execution management information stored in the execution management table 27B is also inputted to the frame selection circuit 291B. The execution management table 27B is supposed to store the execution management information whose IPTT is “IPTT_{—}1_{—}0” and “IPTT_{—}1_{—}1” in the present embodiment.

The frame selection circuit 291B compares the IPTT of the inputted DATA frame and the IPTT inputted from the execution management table 27B.

Specifically, the frame selection circuit 291B compares the IPTT_phy0 inputted from the input path 292a and the IPTT_{—}1_{—}0 and IPTT_{—}1_{—}1 inputted from the execution management table 27B, and compares the IPTT_phy1 inputted from the input path 292b and the IPTT_{—}1_{—}0 and IPTT_{—}1_{—}1 inputted from the execution management table 27B.

In the case of IPTT_phy0=IPTT_{—}1_{—}0 or IPTT_phy0=IPTT_{—}1_{—}1 as the result of the comparison, the frame selection circuit 291B outputs the DATA_phy0 from the input path 292a to the output path 293b (Transport Layer 26B). In the case of IPTT_phy1=IPTT_{—}1_{—}0 or IPTT_phy1=IPTT_{—}1_{—}1 as the result of the comparison, the frame selection circuit 291B outputs the DATA_phy1 from the input path 292b to the output path 293b (Transport Layer 26B). On the other hand, in other cases, the DATA frame is not transmitted to the output paths 293a (Transport Layer 26A) and 293b (Transport Layer 26B).

In this way, the DATA frame inputted from either one of the Phys 22A and 22B is transferred to the Transport Layer 26A or 26B including the execution management table 27A or 27B having the execution management information equal to the IPTT of the inputted DATA frame.

Returning again to the flowchart in FIG. 8, when the storage device receives the DATA frame from the host computer, the storage device 10 stores the data in the storage medium 50 via the buffer 40 by referring to the execution management table, and then, transmits the RESPONSE frame, indicating whether the writing of the write data is normally completed or not, to the host computer (steps S41 to S42) as in the processes in steps S19 to S20 in FIG. 7. Thus, the process is ended.

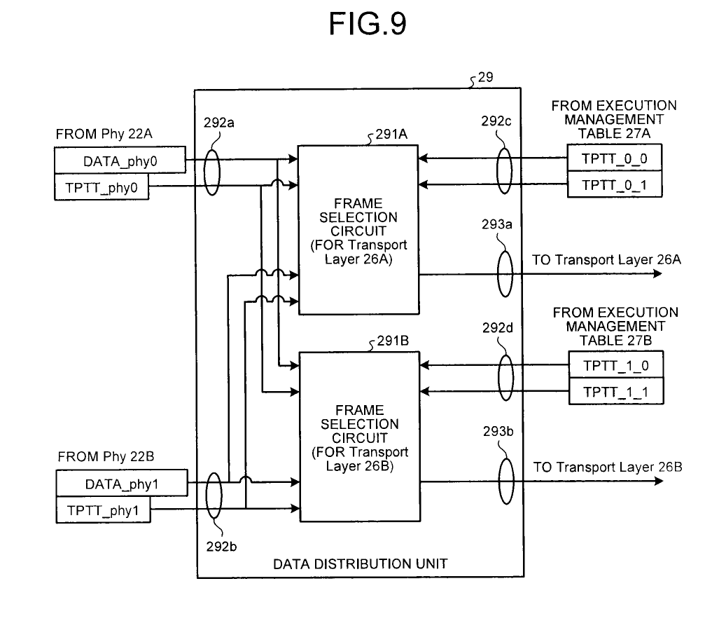

In the description above, the IPTT is used as the identification information. However, the TPTT can be used. FIG. 9 is a view illustrating one example of a data distribution process using the TPTT as the identification information. The process using the TPTT as the identification information is the same as the data distribution process using the IPTT described above. The TPTT in the DATA frame is inputted to the frame selection circuits 291A and 291B via the input path 292a and the 292b, and the TPTT registered to each of the execution management tables 27A and 27B is inputted via the input paths 292c and 292d. The frame selection circuits 291A and 291B determine whether the DATA frame, inputted by using these TPTTs, can be outputted to the output paths 293a and 293b or not.

The SAS module 20 has address management information managing the SAS address allocated to each of Phys 22A and 22B. The storage device can recognize that it is used as the narrow port configuration or the wide port configuration for each Phy by this address management information.

As described above, according to the first embodiment, the storage device 10, which is basically configured as the narrow port configuration including the plural Phys 22A and 22B, and the Port Layers 25A and 25B, the Transport Layers 26A and 26B, and the execution management tables 27A and 27B for each of the Phys 22A and 22B, includes the data distribution unit 29 provided between the plural Phys 22A and 22B and the Transport Layers 26A and 26B over the plural Phys 22A and 22B. The data distribution unit 29 does not operate in the narrow port configuration, but in the wide port configuration, the data distribution unit 29 distributes the DATA frame inputted from each of the Phys 22A and 22B to the Transport Layer 26A or 26B having the execution management table 27A or 27B to which the corresponding identification information is stored. With this structure, the storage device 10 can be used as the narrow port configuration as well as the wide port configuration.

When the narrow port configuration (dual port configuration) and the wide port configuration can both be covered, the dedicated design is needed for each of the execution management tables 27A and 27B and for each of the Transport Layers 26A and 26B. Therefore, the man-hour involved with the design and review might increase. Since the circuit for the narrow port and the circuit for the wide port have to be provided, the circuit scale increases. Therefore, cost increases, and power consumption during the execution also increases. On the other hand, the storage device according to the first embodiment is basically configured as the narrow port configuration, and only includes the data distribution unit 29 without having plural circuits. Therefore, the first embodiment brings an effect of being capable of realizing the narrow port configuration and the wide port configuration with low cost, compared to the ordinary configuration.

### Second Embodiment

In the first embodiment, the data distribution is performed by using the IPTT or TPTT as the identification information. In the second embodiment, the data distribution is performed by using a specific bit in the TPTT.

The configuration of the storage device 10 according to the second embodiment is almost the same as that in FIG. 3. The Transport Layers 26A and 26B allow the TPTT to include the identification information For identifying to which one of the Transport Layers 26A and 26B the target execution management table 27A or 27B is mounted, upon the issuance (setting) of the TPTT. For example, it is preliminarily decided such that, in order to indicate that the command is stored in the execution management table 27A in the storage device 10 having two Phys 22A and 22B illustrated in FIG. 3, the bit [0] in the TPTT is set as “0”, and in order to indicate that the command is stored in the execution management table 27B, the bit [0] in the TPTT is set as “1”.

The number of bits fixedly used can be determined according to the number of the Phys in the wide port (i.e., the number of the execution management tables 27A and 27B). For example, in the wide port configuration having four Phys, two bits are used. In this case, in order to indicate that the command is stored in the first execution management table, the bit [1:0] in the TPTT may be set as “00”; in order to indicate that the command is stored in the second execution management table, the bit [1:0] in the TPTT may be set as “01”; in order to indicate that the command is stored in the third execution management table, the bit [1:0] in the TPTT may be set as “10”; and in order to indicate that the command is stored in the fourth execution management table, the bit [1:0] in the TPTT may be set as “11”.

The data distribution unit 29 has plural frame selection circuits as in the first embodiment. The second embodiment is different from the first embodiment in that each frame selection circuit in the second embodiment compares the specific bit in the TPTT of the received DATA frame and a value set to this frame selection circuit (the value set for identifying the execution management table 27A or 27B mounted to the Transport Layer 26A or 26B to which the frame is to be outputted).

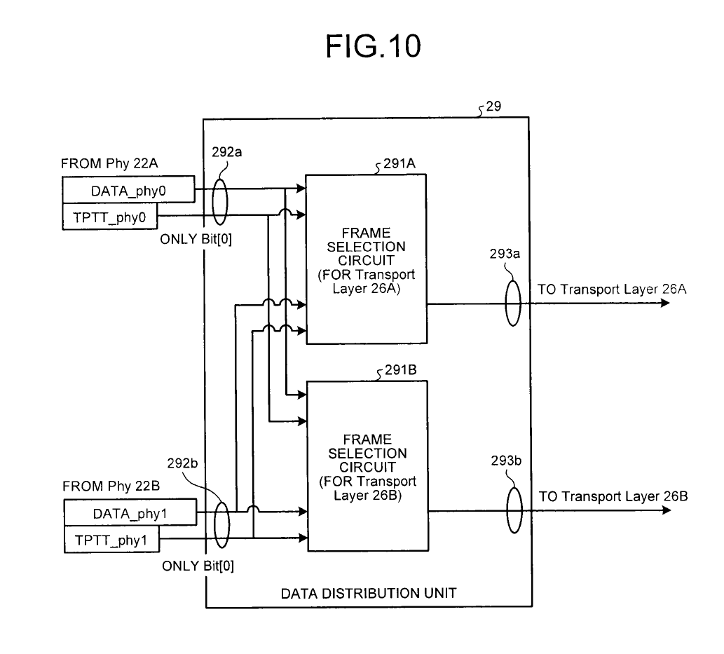

FIG. 10 is a view illustrating one example of a data distribution process by the data distribution unit according to the second embodiment. In this embodiment, there are two Phys 22A and 22B (the Transport Layers 26A and 26B to which the execution management tables 27A and 27B are mounted).

### (1) Distribution Process in Frame Selection Circuit 291A

The DATA_phy0 from the input path 292a and the DATA_phy1 from the input path 292b are inputted to the frame selection circuit 291A. In this embodiment, the TPTT of the DATA_phy0 is defined as “TPTT_phy0”, and the TPTT of the DATA_phy1 is defined as “TPTT_phy1”.

The frame selection circuit 291A checks the specific bit in the TPTT_phy0 inputted from the input path 292a and the specific bit in the TPTT_phy1 inputted from the input path 292b.

Specifically, the frame selection circuit 291A compares the specific bit (e.g., the bit [0]) in the TPTT of the inputted DATA frame and the “0” for identifying the Transport Layer 26A that is the destination to which the DATA frame is to be outputted.

In the case of TPTT_phy0[0]=0, the DATA_phy0 is outputted to the Transport Layer 26A via the output path 293a. In the case of TPTT_phy1[0]=0, the DATA_phy1 is outputted to the Transport Layer 26A via the output path 293a. On the other hand, in other cases, the DATA frame is not transmitted to the Transport Layer 26A.

### (2) Distribution Process in Frame Selection Circuit 291B

The DATA_phy0, having the TPTT of the “TPTT_phy0”, from the input path 292a and the DATA_phy1, having the TPTT of the “TPTT_phy1”, from the input path 292b are inputted to the frame selection circuit 291B.

The frame selection circuit 291B checks the specific bit in the TPTT_phy0 inputted from the input path 292a and the specific bit in the TPTT_phy1 inputted from the input path 292b.

Specifically, the frame selection circuit 291B compares the specific bit (e.g., the bit [0]) in the TPTT of the inputted DATA frame and the “1” for identifying the Transport Layer 26B that is the destination to which the DATA frame is to be outputted.

In the case of TPTT_phy0[0]=1, the DATA_phy0 is outputted to the Transport Layer 26B via the output path 293b. In the case of TPTT_phy1[0]=1, the DATA_phy1 is outputted to the Transport Layer 26B via the output path 293b. On the other hand, in other cases, the DATA frame is not transmitted to the Transport Layer 26B.

The other process is the same as that in the first embodiment, so that the description will not be repeated.

In the second embodiment, the identification information indicating to which one of the Transport Layers 26A and 26B the target execution management table 27A or 27B is mounted is fixedly set to the TPTT, and the distribution destination is determined only by checking the predetermined position of the TPTT of the DATA frame. Therefore, it is unnecessary to input the IPTT or the TPTT to the data distribution unit 29 from the execution management table 27A or 27B, which process is performed in the first embodiment. In addition, only the specific bit in the TPTT in the received DATA frame is compared. Accordingly, the second embodiment brings an effect of being capable of reducing the circuit scale, compared to the first embodiment.

In the description above, the storage device 10 includes two Phys 22A and 22B. However, the embodiments are not limited thereto. The above-mentioned embodiment is similarly applicable to a storage device 10 having three or more Phys.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system that is connected to a host computer with plural transmission paths, and writes data to a non-volatile memory by a write command from the host computer, the memory system comprising:
a plurality of processing units, each of which includes an input/output unit that transmits and receives data with the host computer; and a write control unit that has execution management information for queuing write commands, the execution management information including identification information indicating a process involved with the write command, and that controls a writing of data to the non-volatile memory based upon the execution management information, and each of which is provided for each transmission path; and
a data distribution unit that distributes a data frame received from any one of the input/output units to any one of the write control units based upon the identification information in the data frame, wherein
the data distribution unit distributes the data frame to the write control unit that has the execution management information including identification information equal to the identification information in the received data frame, in the case of a first configuration in which the same address is set to the input/output units in the plurality of processing units, while the data distribution unit does not distribute the data frame, but transfers the data frame to the write control unit in the processing unit including the input/output unit from which the data frame is received, in the case of a second configuration in which a different address is set to the input/output unit in each of the processing units.

2. The memory system according to claim 1, wherein
the data distribution unit includes a frame selection circuit in a number equal to the number of the processing units, and
the frame selection circuit includes a first input path that receives the data frame from all of the input/output units; a second input path that receives the identification information in the execution management information in the write control unit in any one of the processing units; and an output path to the write control unit which is connected to the second input path, and when the identification information in the data frame received from the first input path and the identification information received from the second input path are equal to each other, the frame selection circuit outputs the data frame to the write control unit connected to the output path.

3. The memory system according to claim 2, wherein
the identification information is a number of write data designated by the host computer.

4. The memory system according to claim 2, wherein
the identification information is a number of write data processed by the write command designated by the write control unit.

5. The memory system according to claim 1, wherein
the data distribution unit includes a frame selection circuit in a number equal to the number of the processing units, and
the frame selection circuit includes an input path that receives the data frame from all of the input/output units; and an output path that is connected to the write control unit in any one of the processing units, and when a specific value in the identification information in the data frame received from the input path and a fixed identifier for identifying the transmission path connected to the frame selection circuit are equal to each other, the frame selection circuit outputs the data frame to the write control unit connected to the output path.

6. The memory system according to claim 5, wherein
the identification information is a number of write data processed by the write command designated by the write control unit,
the write control unit generates the number of the write data by setting the value of the specific bit of the number of the write data as the value of the fixed identifier assigned with respect to the transmission path connected to the write control unit, and
the frame selection circuit distributes the data frame by comparing the value of the specific bit in the identification information in the data frame and the value of the fixed identifier assigned with respect to the transmission path.

7. The memory system according to claim 1, wherein
the write control unit stores data in the non-volatile memory in accordance with LBA in the write command.

8. The memory system according to claim 1, wherein
the non-volatile memory is flash memory or hard disk.

9. A data writing method in a memory system that includes an input/output unit connected to a host computer with a transmission path, and a plurality of processing units, each of which includes a write control unit that writes data into a non-volatile memory, and each of which is provided for each of the transmission paths, the method comprising:
receiving a write command from a first transmission path by a first input/output unit in a first processing unit;
registering execution management information for queuing write commands to a first write control unit in the first processing unit, the execution management information including identification information indicating a process involved with the write command;
distributing the data frame received from the first transmission path via the first input/output unit to the write control unit, having the execution management information including identification information equal to the identification information in the data frame, in any one of the plurality of processing units; and
writing data in the data frame in the non-volatile memory based upon the execution management information by the write control unit to which the data frame is distributed, wherein
in the distribution of the data frame, the data frame is distributed to the write control unit having the execution management information including identification information equal to the identification information in the received data frame, in the case of a first configuration in which the same address is set to the input/output units in the plurality of processing units, and in a second configuration in which a different address is set to each of the input/output units in each of the processing units, the distribution of the data frame is not executed, but the data frame is transferred to the write control unit in the processing unit including the input/output unit from which the data frame is received.

10. The data writing method according to claim 9, wherein
the distribution of the data frame is executed by the frame selection circuit in the number equal to the number of the processing units.

11. The data writing method according to claim 10, wherein
in the distribution of the data frame, each of the frame selection circuits receives the data frame from any one of the input/output units, receives the identification information in the execution management information of the write control unit connected to the frame selection circuit, and compares the identification information in the data frame and the identification information from the execution management information, and when they are equal to each other, the frame selection circuit outputs the data frame to the write control unit connected to the frame selection circuit.

12. The data writing method according to claim 11, wherein
the identification information is a number of write data designated by the host computer.

13. The data writing method according to claim 11, wherein
the identification information is a number of write data processed by the write command designated by the write control unit.

14. The data writing method according to claim 10, wherein
in the distribution of the data frame, each of the frame circuits receives the data frame from any one of the input/output units, and compares a specific value in the identification information in the data frame and a fixed identifier for identifying the transmission path connected to the frame selection circuit, and when they are equal to each other, the frame selection circuit outputs the data frame to the write control unit.

15. The data writing method according to claim 14, wherein
the identification information is a number of write data processed by the write command designated by the write control unit,
in the registration of the execution management information, the write control unit generates the number of the write data by setting the value of the specific bit of the number of the write data as the value of the fixed identifier assigned with respect to the transmission path connected to the write control unit, and
in the distribution of the data frame, the frame selection circuit distributes the data frame by comparing the value of the specific bit in the identification information in the data frame and the value of the fixed identifier assigned with respect to the transmission path.

16. The data writing method according to claim 10, wherein
in the data writing, the data is stored in non-volatile memory in accordance with LBA in the write command.

17. The memory system according to claim 10, wherein
the non-volatile memory is flash memory or hard disk.
